(19) United States
(12) Patent Application Publication
(10) Pub. No.: US 2007/0155644 A1
(43) Pub. Date: Jul. 5, 2007

(54) Environmentally Friendly Solvent Containing Isoamyl Lactate

(75) Inventor: Joel Muse JR., Annapolis, MD (US)

Correspondence Address: KIRKPATRICK & LOCKHART PRESTON GATES ELLIS LLP;HENRY W. OLIVER BUILDING, 535 SMITHFIELD STREET, PITTSBURGH, PA, 15222, US

(73) Assignee: Archer-Daniel-Midland Company, Decatur, IL (US)

(21) Appl. No.: 11/619,059

(22) Filed: Jan. 2, 2007

Related U.S. Application Data
(60) Provisional application No. 60/755,191, filed on Dec. 30, 2005.
(60) Provisional application No. 60/759,364, filed on Jan. 17, 2006.

(51) Int. Cl. C11D 17/00

(52) U.S. Cl. 510/407

(57) ABSTRACT

The present invention relates to a biodegradable, environmentally friendly cleaning solvent composition comprising: (a) about 20 weight percent to about 99.9 weight percent of isoamyl lactate; (b) about 0.1 weight percent to about 60 weight percent of a C₁-C₅ ester of a C₁₆-C₂₂ fatty acid; (c) 0 to about 20 weight percent of a surfactant; (d) 0 to about 20 weight percent of a thickener; and (e) 0 to about 50 weight percent organic solvent. The subject invention further relates to a household cleaning solvent that is comprised of isoamyl lactate and a small amount of a fragrance. The subject invention further relates to a solvent composition comprising: (a) about 10 to about 99.9 weight percent of isoamyl lactate; (b) 0 to about 60 weight percent of a C₁-C₅ ester of a C₁₆-C₂₂ fatty acid; (c) 0 to about 20 weight percent of a surfactant; (d) 0 to about 20 weight percent of a thickener; and (e) 0.1 to about 90 weight percent organic solvent. The present invention also relates to a solvent composition comprising (a) isoamyl lactate and (b) from about 0.1 weight percent to about 10 weight percent of a fragrance.

### CROSS REFERENCE TO RELATED APPLICATION

This application claims the benefit of U.S. Provisional Patent Application Ser. No. 60/755,191, filed on Dec. 30, 2005, and U.S. Provisional Patent Application Ser. No. 60/759,346, filed on Jan. 17, 2006. The teachings of U.S. Provisional Patent Application Ser. No. 60/755,191, and U.S. Provisional Patent Application Ser. No. 60/759,346 are incorporated herein by reference in their entirety.

### TECHNICAL FIELD OF THE INVENTION

This invention relates to a liquid solvent composition that is biodegradable and generally benign to human health. It is highly effective as a solvent for conducting a wide array of tasks. For instance, the solvent compositions of this invention can be utilized in paint removal, de-inking, degreasing, dry cleaning, and as a general surface cleaning agent that provides for a non-toxic, cost effective alternative to commonly used toxic solvents. This liquid solvent composition contains isoamyl lactate, optionally an ester of a fatty acid derived from an edible oil, optionally a biodegradable organic solvent, optionally a surfactant, optionally a thickener, optionally a fragrance, and optionally a colorant.

### BACKGROUND OF THE INVENTION

A solvent is a substance that is generally capable of dissolving another substance, or solute, to form a uniformly dispersed mixture (solution) at the molecular or ionic level. Solvents are either polar (high dielectric constant) or non-polar (low dielectric constant). Water, the most common solvent, is strongly polar having a dielectric constant of 81. Hydrocarbon solvents are non-polar and are comprised of two groups, aliphatics, such as alkanes and alcohols, and aromatics, which generally have a higher solvency power than aliphatics. Other organic solvent groups are esters, ethers, ketones, amines, nitrated hydrocarbons and halogenated hydrocarbons.

Organic solvents are commonly used in the dissolution of coatings (paints, varnishes, and laquers) and in extractive processes. Industrial and household cleaning products also normally contain one or more organic solvents. For instance, dry cleaning fluids and stain removers typically contain organic solvents. Organic solvents are also commonly used in making printing inks. Because many solvents are flammable and toxic to humans and animals, there is a need to develop safer solvents for commercial use without sacrificing performance characteristics. It is desirable for such solvents to be free of halogens and to be biodegradable.

For decades industrial and household cleaning products have been utilized as paint removers, dry cleaning fluids, spot removers, ink removers, degreasers, etc. Solvents are also used to clean, maintain, and prepare wood, metal, masonry, natural and synthetic fabrics, plastic components, and electronic components. Most of the solvents currently being used in these applications pose some degree of threat to human and animal health and to the environment. In fact, some solvent systems currently being used are toxic and potentially carcinogenic

Although government, industry and the general public are relatively well informed with respect to the dangers of toxic solvents, this knowledge has not dramatically reduced their use. Safer handling, disposal, recycling, recovery and other responsible methods of dealing with toxic substances are improving. However, safer alternative solvents that are highly effective and that can be used without sacrificing performance characteristics are not typically available for many applications. This is because the majority of environmentally safer solvents do not provide satisfactory performance. Environmentally friendly solvents also failed to come into wide spread use because of their higher cost.

An environmentally friendly solvent must meet several criteria to gain wide spread acceptance as an alternative to conventional solvent systems. It should provide effective performance. The environmentally friendly solvent should also be economically viable and affordable. Finally, it should be widely available and non-toxic to humans, plants and animals.

Many alternative solvents systems for various applications have been introduced over the course of the last few decades. However, these new solvents have not generally met all of the criteria stated above.

U.S. Pat. No. 5,372,742 discloses a non-aqueous cleaning composition that can be used as a finger nail polish remover which contains d-limonene, ethyl lactate, cetyl acetate, and optionally, propylene glycol methyl ether acetate.

U.S. Pat. No. 6,096,699 discloses an environmentally friendly solvent that is reported to be useful as a paint stripping composition which contains (a) about 10 to about 15 weight percent of a C₁-C₄ ester of a C₁₆-C₂₀ fatty acid having a melting point of −10° C. or less; (b) about 70 to about 75 weight percent of a C₁-C₄ ester of lactic acid; (c) about 4 to about 7 weight percent of a surfactant; and (d) about 4 to about 7 weight percent of a thickener, said composition being a homogeneous liquid or gel at 0° C. and having a flash point in excess of 93° C.

U.S. Pat. No. 6,797,684 discloses a biosolvent that is reported to have improved cleaning and solvating properties that contains 20 weight percent to 80 weight percent of a C₁-C₄ ester of lactic acid and about 20 weight percent to about 80 weight percent of d-limonene.

U.S. Pat. No. 6,890,893 discloses a biosolvent that contains a C₁-C₄ lactate ester and an odor-reducing amount of a tertiary amine having a boiling point at one atmosphere of about 80° C. to about 160° C., said composition (a) being substantially free of odor due to said tertiary amine as compared to the same composition without the tertiary amine, (b) exhibiting a reduced amount of odor due to said lactate ester, and (c) being a homogeneous liquid at 0° C.

### SUMMARY OF THE INVENTION

The present invention contemplates an environmentally friendly solvent. This solvent is biodegradable in normal sewerage treatment plants, and has a low volatile content so that it can be used indoors with minimal ventilation.

The subject invention more specifically discloses a solvent composition comprising: (A) about 20 weight percent to about 99.9 weight percent of isoamyl lactate; (B) about 0.1 weight percent to about 60 weight percent of a C₁-C₅ ester of a C₁₆-C₂₂ fatty acid; (C) 0 weight percent to about 20 weight percent of a surfactant; (D) 0 weight percent to about 20 weight percent of a thickener; and (E) 0 weight percent to about 50 weight percent organic solvent. This solvent composition is typically a homogeneous liquid or gel at 0° C. and has a closed cup flash point in excess of 60° C.

The present invention also reveals a solvent composition comprising (a) isoamyl lactate and (b) about 0.1 to about 10 weight percent of a fragrance. The fragrance will typically be a pine scent, a mint scent, a citrus scent (such as lemon or lime), or some other pleasant smelling material. The subject invention further discloses a solvent composition comprising (a) isoamyl lactate and (b) from about 0.5 weight percent to about 20 weight percent of a surfactant. The present invention also reveals a solvent composition comprising (a) isoamyl lactate and (b) from about 0.5 weight percent to about 20 weight percent of an organic solvent.

The present invention further discloses a solvent composition comprising: (a) about 10 to about 75 weight percent of a C₁-C₅ ester of lactic acid; (b) about 10 to about 60 weight percent of a C₅ ester of a C₁₆-C₂₂ fatty acid; (c) 0 weight percent to about 20 weight percent of a surfactant; (d) 0 weight percent to about 20 weight percent of a thickener; and (e) 0 weight percent to about 50 weight percent organic solvent.

In one preferred embodiment, the solvent composition comprises: (A) about 30 weight percent to about 60 weight percent of a C₁-C₅ ester of a C₁₆-C₂₂ fatty acid; (B) about 30 weight percent to about 60 weight percent of isoamyl lactate; (C) 0 weight percent to about 5 weight percent of a surfactant; (D) 0 weight percent to about 10 weight percent of a thickener; and (E) 0 weight percent to about 35 weight percent organic solvent. In the above embodiment, the weight percent of the isoamyl lactate is conveniently equal to the weight percent of the fatty acid ester, plus or minus about 10 weight percent. In another preferred embodiment, the composition comprises: (A) about 20 weight percent to about 40 weight percent of a C₁-C₅ ester of a C₁₆-C₂₂ fatty acid; (B) about 20 weight percent to about 40 weight percent of isoamyl lactate; (C) 0 weight percent to about 20 (preferably 0 to about 5) weight percent of a surfactant; (D) 0 weight percent to about 20 (preferably 0 to about 10) weight percent of a thickener; and (E) 0 weight percent to about 35 (preferably 0 to about 20) weight percent of an organic solvent.

In each of the embodiments of the invention, the particularly preferred C₁-C₅ ester of a C₁₆-C₂₂ fatty acid is an ester of a mixture of oleic and linoleic acids. The methyl ester is a representative example of a preferred ester, and the fatty acid mixture is preferably that of soybean oil with methyl soyate being particularly preferred

The present invention has several benefits and advantages. One benefit of the invention is that a contemplated composition is much safer than a halogenated organic solvent. A related advantage is that a contemplated composition can be used in occupied areas.

A benefit of a composition according to the present invention is that it has a closed cup flash point greater than about 60° C. An additional advantage of the present invention is that the cleaning solvent can be formulated to be partially miscible with water, and thus can be removed with water rinsing, including high pressure water. This rinsing factor can offer some industrial advantages that do not exist with traditional cleaning solvents. Yet another benefit of a preferred embodiment of the present invention is that it is biodegradable, non-toxic, and is derived from corn, soybeans, palm, and/or other vegetable oils which are, of course, renewable.

### DETAILED DESCRIPTION OF THE INVENTION

The present invention contemplates an alternative solvent for a multitude of tasks that are commonly practiced today. Separately, isoamyl lactate based solvents, wholly or in combination with other solvents, thixotropic agents, surfactants, pH adjusters and fragrance can be prepared. In addition, C₁-C₅ esters of fatty acids derived from edible oils can be used in conjunction with isoamyl lactate in certain solvent and cleaning applications.

Isoamyl lactate is normally made by reacting isoamyl alcohol with ethyl lactate at a 1:1 molar ratio. This reaction is typically conducted in the presence of a strong acid or base to facilitate a transesterification reaction. Alternatively, isamyl alcohol can be reacted with lactic acid in the presence of acid to facilitate a direct esterification reaction. In either case, for instance, the reaction can be catalyzed with hydrochloric acid, sulfuric acid, or trifluoroacetic acid.

It has been found that a small amount of a fragrance can be blended into isoamyl lactate to provide it with the pleasant scent needed in household cleaning applications as a stain or spot remover. In industrial applications a fragrance is not required, but it is desirable to include an emulsifier and/or an organic solvent in the solvent composition to enhance performance characteristics. In some household applications it is also desirable to include an emulsifier and/or an organic solvent in addition to the fragrance to attain the desired performance characteristics.

Since isoamyl lactate has a flash point in excess of 60° C. it is not always necessary to add a C₁-C₅ ester of a C₁₆-C₂₂ fatty acid to the solvent compositions of this invention to attain a minimum flash point. However, a C₁-C₅ ester of a C₁₆-C₂₂ fatty acid can be added to further increase the flash point of the solvent system and/or to attain better performance characteristics. Such a contemplated solvent composition broadly comprises a solvent blend of about 10 to about 60 weight percent of isoamyl lactate and about 20 to about 75 weight percent C₁-C₅ ester of a C₁₆-C₂₂ fatty acid, the latter fatty acid esters typically being a mixture of esters linoleic and oleic acid. This blended solvent can provide beneficial properties not achieved separately or in combination with other solvent blends.

Another contemplated solvent blend composition comprises (A) about 10 weight percent to about 60 weight percent C₁-C₅ ester of a C₁₆-C₂₂ fatty acid; (B) about 20 weight percent to about 75 weight percent of isoamyl lactate; (C) 0 weight percent to about 20 weight percent of a surfactant; (D) 0 weight percent to about 20 (preferably 0 to about 10) weight percent of a thickener; and (E) 0 weight percent to about 50 (preferably 0 to about 35 and more preferably 0 to about 20) weight percent of an organic solvent.

The composition can be a homogeneous liquid or gel at 0° C. and has a closed cup flash point in excess of 60° C., and preferably in excess of 70° C. One preferred composition comprises (A) about 30 weight percent to about 60 weight percent of a C₁-C₅ ester of a C₁₆-C₂₂ fatty acid; (B) about 30 weight percent to about 60 weight percent of isoamyl lactate; (C) 0 weight percent to about 20 (preferably 0 to about 10) weight percent of a surfactant; and (D) 0 weight percent to about 20 weight percent of a thickener; and (E) 0 weight percent to about 20 weight percent of an organic solvent. The weight percent of the isomayl lactate can be equal to the weight percent of the fatty acid ester, for instance plus or minus about 10 percent.

Another preferred composition comprises (A) about 20 to about 40 weight percent of a C₁-C₅ ester of a C₁₆-C₂₂ fatty acid; (B) about 20 weight percent to about 40 weight percent of isoamyl lactate; (C) 0 weight percent to about 5 weight percent of a surfactant; and (D) 0 weight percent to about 5 weight percent of a thickener; and (E) 0 weight percent to about 35 weight percent of an organic solvent.

The above preferred embodiment compositions are homogeneous liquids or gels at 0° C. and have a closed cup flash point in excess of 60° C. (139° F.) [ASTM D93-90], preferably in excess of 70° C. A contemplated C₁-C₅ ester of a C₁₆-C₂₂ fatty acid is an ester of a fatty acid derived (hydrolyzed) from a so-called “edible” vegetable oil. Vegetable oils are comprised of fatty acid triglyceride esters. Hydrolysis of the vegetable oil esters frees the fatty acids, from which the C₁-C₅ esters are made. Preferred edible vegetable oils include, without limitation, corn, mustard, palm, niger-seed, olive, peanut, poppy-seed, safflower, rape-seed, sesame, soybean, sunflower-seed, coconut, wheat-germ oil, and mixtures thereof. In some cases it is desirable for the C₁-C₅ ester of the C₁₆-C₂₂ fatty acid to have a melting point of −10° C. or less.

Commercial sources of isoamyl alcohol derived from fusel oil also contain 2-methyl-1-butanol. This mixture is sometimes referred to as “single peak isoamyl alcohol” because the isoamyl alcohol (3-methyl-1-butanol) and the 2-methyl-1-butanol have boiling points that only differ by 4° C. More specifically, isoamyl alcohol has a boiling point of 132° C. and 2-methyl-1-butanol has a boiling point of 128° C. In such mixtures the ratio of isoamyl alcohol to 2-methyl-1-butanol is normally about 4:1. Such mixtures of isoamyl alcohol and 2-methyl-1-butanol can be used as the alcohol source for the isoamyl lactate that is employed in the practice of this invention. Accordingly, the isoamyl lactate utilized in the practice of this invention can also contain 2-methyl-1-butyl lactate. Such compositions will normally contain about 80 weight percent isoamyl lactate and about 20 weight percent 2-methyl-1-butyl lactate.

The C₁₆-C₂₂ fatty acid is typically comprised of a mixture whose fatty acids are constituted by about 50 to about 90 percent unsaturated fatty acids such as oleic, linoleic, erucic and linolenic acids. Fatty acid esters derived from edible vegetable oils containing a mixture of about 50 to about 90 weight percent oleic and linoleic acids are more preferred. In many cases it is preferred for the C₁₆-C₂₂ fatty acid mixture to contain from about 70 to about 90 percent unsaturated fatty acids. However, in some applications (for instance, where discoloration and/or odor generation are problematic) it can be desirable for the mixture to contain less than 50 percent unsaturated fatty acids and to contain up to about 80 weight percent saturated fatty acids. Soybean oil, which is comprised principally of oleic and linoleic acids is the source of the preferred C₁₆-C₂₂ fatty acid. A methyl (C₁) ester is the preferred C₁-C₅ group. A particularly preferred contemplated C₁-C₅ ester of a C₁₆-C₂₂ fatty acid is methyl soyate. In some cases it is preferred for the C₁-C₅ group to be an isoamyl group (C₅).

In one embodiment of this invention a C₁-C₄ ester of lactic acid is used in the solvent composition in conjunction with the isoamyl lactate. In such cases the C₁-C₄ ester of lactic acid will preferably be ethyl lactate. Exemplary C₁-C₄ alcohols that can comprise the C₁-C₄ ester portion of a lactate ester or of a C₁₆-C₂₂ fatty acid ester include methanol, ethanol, propanol, isopropanol, allyl alcohol, butanol, 3-buten-1-ol, t-butanol, iso-butanol, and sec-butanol.

In some contemplated embodiments, the C₁-C₄ ester of a C₁₆-C₂₀ fatty acid is present at about 10 to about 60 weight percent and the isoamyl lactate is present at about 20 to about 75 weight percent. In preferred embodiments, each of these two ingredients is present at about 30 to about 60 weight percent.

A contemplated composition can also contain up to about 50 weight percent of an organic solvent. A contemplated solvent is biodegradable and can be illustrated by a solvent including but not limited to mixed methyl esters of C₄-C₆ dibasic acids, N-methylpyrrolidone (NMP), d-limonene, tetrahydrofurfuryl alcohol (THFA) and di-C₂-C₃ alkylene glycol mono and di-C₁-C₆ alkyl ethers such as dipropylene glycol n-butyl ether (DPNB), dipropylene glycol methyl ether, diethylene glycol t-butyl methyl ether and diethylene glycol butyl ether. Preferably, the organic solvent is a C₁-C₅ ester of a C₃-C₁₀ dicarboxylic acid, as discussed below. Other representative examples of specific organic solvents that can be used include phenol, cresols, catechol, resorcinol, salicylic acid, methylene chloride, perchloroethylene, formic acid, acetic acid, proprionic acid, lactic acid, monoglycerides of C₁₀-C₂₂ fatty acids, and alkyl esters including, but not limited to, ethyl acetate, ethyl propionate, ethyl butyrate, ethyl isovalerate, ethyl benzoate, propyl acetate, propyl proprionate, propyl butyrate, propyl isovalerate, isoamyl acetate, isoamyl proprionate, isoamyl butyrate, isoamyl isovalerate, and esters of fusel oil, including acetates, proprionates, butyrates, lactates, and isovalerates. A contemplated organic solvent is free of halogens. The organic solvent plays a role as a useful bridging solvent, helping to maintain a homogeneous solution and helping to dissolve assorted components.

For use as an organic solvent with the invention, mixed methyl esters of C₃-C₁₀ dibasic acids include C₄-C₆ dibasic acid esters that are commercially available from DuPont Nylon Intermediates and Specialties, Wilmington, Del. under the designation DBE. Seven DBE fractions are available that differ in the amounts of each of three diesters (dimethyl adipate [C₆] dimethyl glutarate [C₅] and dimethyl succinate [C₄]) present. Each of the products is useful, with the material sold as DBE-3 being preferred. That material is said by its manufacturer to contain 89 weight percent dimethyl adipate, 10 weight percent dimethyl glutarate and 0.2 weight percent dimethyl succinate.

A contemplated composition can also contain up to about 20 weight percent of a surfactant. Lesser amounts of surfactant than the full 20 weight percent are typically present when a surfactant is utilized, as is illustrated by the above-enumerated preferred embodiments and the examples that follow.

Surfactants that can be used in the solvent systems of this invention are named herein following the nomenclature system of the International Cosmetic Ingredient Dictionary, 5^{th} ed., J. A. Wenninger et al. eds., The Cosmetic, Toiletry, and Fragrance Association, Washington, D.C. (1993), usually followed by a chemical name and a trademark name of a particular product. Exemplary surfactants are isotridecyl alcohol tri-ethoxylate (Surfonic® TDA-3B, Huntsman Corp.), C₉-C₁₁ pareth-6 [polyethylene glycol ether of mixed synthetic C₉-C₁₁ fatty alcohols having an average of 6 moles of ethoxylate; Neodo® 91.6], C₁₁-C₁₅ pareth-59 [polyethylene glycol ether of mixed synthetic C₁₁-C₁₅ fatty alcohols having an average of 59 moles of ethoxylate; Tergitol® 15-S-59], nonoxynol-6 [polyethylene glycol (6) nonylphenyl ether; Tergitol® NP-6], nonoxynol-9 [polyethylene glycol (9) nonylphenyl ether; Tergitol® NP-9], and a modified alkanolamide alkanolamine [Monamine® 12551

Surfactants containing aromatic groups, such as nonylphenyl groups, are less preferred because they are not as biodegradable as the others. Preferred surfactants are branched and linear alcohol ethoxylates. Most preferred surfactants are alcohol ethoxylates. The addition of a surfactant to a composition comprising a C₁-C₅ ester of a C₁₆-C₂₂ fatty acid is preferred. The addition of a surfactant typically makes the cleaner more effective.

A contemplated solvent composition can also include a thickener that provides a “gel-like” consistency to the composition to minimize drip and running of the composition when applied to surfaces that are not horizontal, such as walls. Such a thickened consistency can also be useful in an application to a horizontal surface. It is unknown whether a contemplated thickened composition is technically a gel, but that term is used herein to mean a non-solid composition at room temperature that is spreadable, but non-pourable or essentially non-pourable at room temperature.

Preferred thickeners are polysaccharide derivatives having nonionic functionalities such as alkyl alcohol or ether groups. Exemplary thickeners include methyl cellulose, hydroxyethyl cellulose, hydroxypropyl cellulose, hydroxypropyl methyl cellulose, corn starch, hydroxyethyl corn starch, and hydroxypropyl corn starch. Exemplary preferred thickeners include Propylene Glycol Thickener Klucel®-H and Baragel Methocel® 311.

Contemplated compositions are partially miscible with water, unlike many petrochemical-based cleaning solvents. Water miscibility is advantageous, because it is easier to handle the cleaning solutions, dispose of them, dilute them and rinse them off of components. A biodegradable solution of the invention can be degraded in standard sewerage treatment plants, as opposed to special chemical waste handling procedures.

A contemplated composition is substantially free of added water. Thus, although some water can be present as a result of being an impurity of a constituent, water is typically not added to a composition, and a composition typically contains 5 weight percent water or less. The weight percent of the compositions described herein refers to the weight percent of the organic phase, and does not include the mass of any added water. A contemplated composition is also substantially free of halogenated compounds so that only contaminating amounts of such materials are present. However, in other contemplated formulations, such as paint removers, halogenated compounds can be included in the solvent composition. For instance, such a paint remover composition can contain isoamyl lactate, phenol, methylene chloride, and formic acid, lactic acid or salicylic acid.

In another contemplated embodiment of this invention the solvent composition is emulsified and mixed with up about 95 weight percent water. For instance, a concentrate of the solvent composition can be admixed with water and emulsified prior to use.

While certain representative embodiments and details have been shown for the purpose of illustrating the subject invention, it will be apparent to those skilled in this art that various changes and modifications can be made therein without departing from the scope of the subject invention.

What is claimed is:

1. A solvent composition comprising: (a) about 20 to about 99.9 weight percent of isoamyl lactate; (b) about 0.1 to about 60 weight percent of a C₁-C₅ ester of a C₁₆-C₂₂ fatty acid; (c) 0 to about 20 weight percent of a surfactant; (d) 0 to about 20 weight percent of a thickener; and (e) 0 to about 50 weight percent of an organic solvent.

2. A solvent composition comprising (a) isoamyl lactate and (b) a member selected from the group consisting of surfactants, organic solvents, and d-limonene.

3. A paint remover composition comprising (a) isoamyl lactate, (b) phenol, and (c) at least one member selected from the group consisting of formic acid, lactic acid, and salicylic acid.

4. A solvent composition comprising: (a) about 10 to about 90 weight percent of a C₁-C₅ ester of lactic acid; (b) about 10 to about 60 weight percent of a C₅ ester of a C₁₆-C₂₂ fatty acid; (c) 0 weight percent to about 20 weight percent of a surfactant; (d) 0 weight percent to about 20 weight percent of a thickener; and (e) 0 weight percent to about 50 weight percent organic solvent.

5. A solvent composition comprising a first lactate component and a second lactate component, wherein the first lactate component and the second lactate component are selected from the group consisting of ethyl lactate, propyl lactate, butyl lactate, and isoamyl lactate, with the proviso that the first lactate component is different from the second lactate component.

6. A method for cleaning a substrate which comprises exposing the substrate to the solvent composition as specified in claim 1.

7. A method for cleaning a substrate which comprises exposing the substrate to the solvent composition as specified in claim 2.

8. A method for cleaning a substrate which comprises exposing the substrate to the solvent composition as specified in claim 4.

9. A method for cleaning a substrate which comprises exposing the substrate to the solvent composition as specified in claim 5.

10. The composition according to claim 1 wherein said C₁-C₅ ester of a C₁₆-C₂₂ fatty acid is present at a level which is within the range of about 30 weight percent to about 60 weight percent.

11. The composition according to claim 1 wherein said isoamyl lactate is present at a level which is within the range of about 30 weight percent to about 60 weight percent.

12. The composition according to claim 1 wherein said fatty acid C₁-C₅ ester is a methyl ester.

13. The composition according to claim 1 wherein said fatty acid methyl ester is a methyl ester derived from at least one edible oil selected from the group consisting of corn, mustard, niger-seed, olive, peanut, poppy-seed, rape-seed, safflower, sesame, soybean, palm, sunflower-seed and wheat-germ.

14. The composition according to claim 1 wherein the organic solvent is at least one member selected from the group consisting of phenol, cresols, catechol, resorcinol, salicylic acid, methylene chloride, perchloroethylene, formic acid, acetic acid, proprionic acid, lactic acid, monoglycerides of C₁₀-G₂₂ fatty acids, ethyl acetate, ethyl propionate, ethyl butyrate, ethyl isovalerate, ethyl benzoate, propyl acetate, propyl proprionate, propyl butyrate, propyl isovalerate, butyl acetate, butyl propionate, butyl butyrate, butyl isovalerate, isoamyl acetate, isoamyl proprionate, normal-amyl proprionate, isoamyl butyrate, isoamyl isovalerate, ethanol, propanol, butanol, isoamyl alcohol, ethyl lactate, propyl lactate, butyl lactate, mixed methyl esters of C₃-C₁₀ dibasic acids, N-methylpyrrolidone, d-limonene, tetrahydrofurfuryl alcohol and a di-C₂-C₃ alkylene glycol mono and di-C₁-C₆ alkyl ether.

15. The composition according to claim 1 wherein the C₁-C₅ ester of the C₁₆-C₂₂ fatty acid is an isoamyl ester.

16. The composition according to claim 1 wherein said C₁-C₅ ester of a C₁₆-C₂₂ fatty acid is comprised of a mixture of C₁-C₅ esters of fatty acids containing about 70 to about 90 percent unsaturated fatty acids.

17. The composition according to claim 1 wherein the organic solvent is a mixture of esters of fusel oil.

18. A solvent composition as specified in claim 5 wherein the first lactate component is ethyl lactate, wherein the ethyl lactate is present at a level which is within the range of 5 weight percent to 80 weight percent, and wherein the second lactate component is present at a level which is within the range of 20 weight percent to 95 weight percent.

19. A solvent composition as specified in claim 5 wherein the first lactate component is ethyl lactate, wherein the ethyl lactate is present at a level which is within the range of 30 weight percent to 60 weight percent, and wherein the second lactate component is present at a level which is within the range of 30 weight percent to 60 weight percent.

20. The paint remover composition specified in claim 3 which is further comprised of methylene chloride.
